(19) United States
(12) Patent Application Publication
(10) Pub. No.: US 2010/0192488 A1
(43) Pub. Date: Aug. 5, 2010

(54) Mullion System

(75) Inventors: Colin D. CAMPBELL, Daleville, VA (US); James M. BOWLING, Ferrum, VA (US)

Correspondence Address: LATHROP & GAGE LLP, 2345 GRAND Boulevard, SUITE 2400, KANSAS CITY, MO, 64108, US

(73) Assignee: PLY GEM PACIFIC WINDOWS CORPORATION, Kearney, MO (US)

(21) Appl. No.: 12/364,954

(22) Filed: Feb. 3, 2009

(51) Int. Cl. E06B 3/04; E06B 7/14

(52) U.S. Cl. 52/209; 52/204.5

(57) ABSTRACT

A mullion system includes a universal reinforcement key, that joins window frame members and when anchored in a window frame opening or against other window frame joining members, contributes to bearing the load on the window frame unit. The system also includes a mull strip member with end caps designed to weep moisture away from and out of the window frame unit.

### TECHNICAL FIELD

The disclosed subject matter relates generally to window assemblies, and specifically to a reinforcing mullion system that provides greater strength and rigidity to a window system as well as allowing for water to be diverted out of the mullion and away from the building.

### BACKGROUND

Mullion systems or mullions provide the central support between a divided window structure. Mullion strength is an important factor for providing wind load resistance to a window. The significance of the mullion is amplified with an increase in the number of adjacent windows and different combinations of windows sought after by builders in order to guarantee a strong window assembly. As the size of the window assembly is increased, the mullion must provide enough reinforcement to ensure the safety of the system.

Mullion systems have traditionally been designed to reinforce adjacent wall panels or windows. However, conventional mullion systems are often difficult to assemble or performance rate as complete window systems. This has limited the number of window combinations that meet new building codes and performance standards (such as AAMA 450 detailed below), especially in places where harsh conditions are a factor, such as coastal regions where hurricanes are prevalent, or in the Midwest, where tornadoes are common.

Additionally, with the increase in frequency and severity of weather events, mullion standards have been raised significantly. One of these raised standards, that has emerged as a leading standard, is the American Architectural Manufacturers Association's (AAMA) 450 Performance Rating Method for Mulled Fenestration Assemblies. It provides specifications for mullion systems with greater resistance to severe weather, than existed previously.

The AAMA 450 rating determines the air infiltration, water resistance, and structural performance of mulled fenestration assemblies. This higher standard has limited the number of suitable mullion systems that are available for multi-window constructions.

Additionally, anchored or fixed mullions are presently available in the form of “T” and “X” mullions. However, these anchored “T” and “X” mullions are formed of multiple, non-interchangeable parts and are difficult to assemble.

Furthermore, some conventional mullion systems suffer from rot and/or corrosion. For example, windows can lose their water tight seal from the time of manufacture until the time they are installed. This could be the result of stresses developed during shipping and handling, or simply improper handling and/or installation of the window system, as well as the improper assembly of the mullion itself.

### SUMMARY

The disclosed subject matter provides a mullion system for use in forming an assembly of windows, that can meet all current standards, including AAMA 450. The disclosed system is formed of common parts and is easy to assemble. The disclosed system also accommodates a calculation method to determine the structural strength and safety of the system, and as such each system may be rated for safety and performance.

This disclosed system uses a reinforcement key, which is universal. The key joins reinforcement members together. The key is also designed to engage an opening in the respective gusset plate. The gusset plate is attached to the rough window opening, allowing the sharing of the wind load with the screws holding the gusset plate. The key is also designed to sit in a groove in a member, in order to join to perpendicularly disposed reinforcements. This leads to a stronger mullion system, when compared to conventional mullion systems, where the screws carried all of the wind load.

The reinforcement key, as well as the components forming the reinforcements, and gusset plates of the mullion system are universally sized. Accordingly, these components can be fit together, to form a solid reinforcing system. Also, this universal sizing allows the components to be used in “T” and “X” mullions.

The mullion system is also modular. This allows for multiple window configurations that can still meet the AAMA 450 specification. Moreover, the same components are used in all orientations and interlock the same from all orientations.

The mullion system also provides a method of diverting water away from the window units. An upper leg on a horizontal mull strip is designed to direct water toward the exterior of the window, and away from the structure.

An embodiment of the disclosed subject matter is directed to a mullion system for providing improved structural rigidity. The system includes a first component for being fastened to the frame of a first window unit; a second component for being fastened to the frame of a second window unit; and, a removably attachable reinforcement key. The key is configured for joining the first component to the second component, and a leading portion of the reinforcement key extends beyond the edges of the first component and the second component. This portion that extends is designed for receipt in a securement member, for example, a gusset plate.

Another embodiment is directed to a system for placement between parallel oriented window frames for facilitating liquid flow out of the system. The system includes a strip covered by a cap, the strip sitting between the parallel oriented window frames, the parallel orientation being either vertical or horizontal. The strip includes oppositely disposed ends, a main member including oppositely disposed first and second edges, a first lateral member extending from the main member proximate to the first edge, and a second lateral member extending from the main member proximate to the second edge. The first lateral member and the second lateral member extend substantially the same distance from the main member. There is at least one cap, and typically two caps, for covering the strip at each of the oppositely disposed ends. The caps include an inner side including at least one opening to the ambient environment, with the inner side configured for facilitating movement of liquid to the opening for egress from the cap.

Another embodiment is directed to a system for placement between vertically oriented window frames for diverting liquid. The system includes a strip for placement into a space between vertically oriented window frames, and caps, for placement at opposite ends of the strip. The strip includes oppositely disposed ends, and a main member including an upper edge and a lower edge, a first lateral member protruding from the main member proximate to the lower edge, and, a second lateral member protruding upward from the main member proximate to the upper edge. The first lateral member and the second lateral member extend at least substantially the same distance as the main member. The caps are designed to frictionally fit in an area formed by the ends of the strip and portions of the window frames. The caps include an inner side and at least one opening to the ambient environment, the inner side designed for receiving and facilitating movement of liquid to the opening for egress from the at least one cap.

### BRIEF DESCRIPTION OF THE DRAWINGS

Attention is now directed to the drawing figures, where like or corresponding numerals indicate like or corresponding components. In the drawings:

FIG. 1A is a perspective view of a window system installed in a rough opening of a building using the disclosed mullion system;

FIG. 1B is a perspective view of a window system of two windows with a vertical mull strip between them, installed in a rough opening of a building using the disclosed mullion system;

FIG. 2 is perspective view of the mullion system installed inside a rough opening with the window frames removed;

FIG. 3 is a close up of the interior connection of the mullion system of FIG. 2;

FIG. 4 is an exploded view showing a vertical portion of the disclosed mullion system;

FIG. 5A is a cross-sectional view of a paired members of a mullion reinforcement including finger portions;

FIG. 5B is a cross-sectional view of alternate finger portions of FIG. 5A;

FIGS. 6A and 6B are perspective views of gusset plates of the disclosed mullion system;

FIGS. 7, 8A, 8B, 9, 10 are exploded views of a sequence of assembly steps for the vertical reinforcement of the disclosed mullion system;

FIG. 11 is a perspective view of the completed assembly of the vertical reinforcement of the disclosed mullion system;

FIGS. 12, 13A, 13B and 14 are exploded views of a sequence of assembly steps for the horizontal reinforcement of the disclosed mullion system;

FIG. 15 is a perspective view of the completed assembly of the horizontal reinforcement of the disclosed mullion system;

FIG. 16A is a cross sectional view of the mull strip taken along line 16A-16A of FIG. 7;

FIG. 16B is a cross sectional view of the mull strip in the window frame taken along line 16B-16B of FIG. 11;

FIG. 17A is a cross sectional view of the mull strip taken along line 17A-17A of FIG. 12;

FIG. 17B is a cross sectional view of the mull strip in the window frame taken along line 17B-17B of FIG. 15;

FIG. 18A is a perspective view of an alternate mull strip;

FIG. 18B is a cross sectional view of the mull strip of FIG. 18A taken along line 18B-18B;

FIG. 19A is a perspective view of the outer side of a mull cap;

FIG. 19B is a perspective view of the inner side of the mull cap of FIG. 19A;

FIG. 20 is a perspective view of the inside of the capped mull strip taken along line 20′-20′ of FIG. 1B and 20-20 of FIG. 15, showing fluid flow therethrough; and,

FIGS. 21A and 21B are perspective views of the capped mull strips taken along line 21-21 of FIG. 15, and showing the flow of fluid therethrough.

### DETAILED DESCRIPTION

In this document, references are made to directions, such as upper, lower, top, bottom, up, down, upward, downward, front, rear, side, lateral, right, left, inner, outer, inside, outside, and variations thereof. These directional references are exemplary, to show the disclosed subject matter in an example orientation, and are in no way limiting.

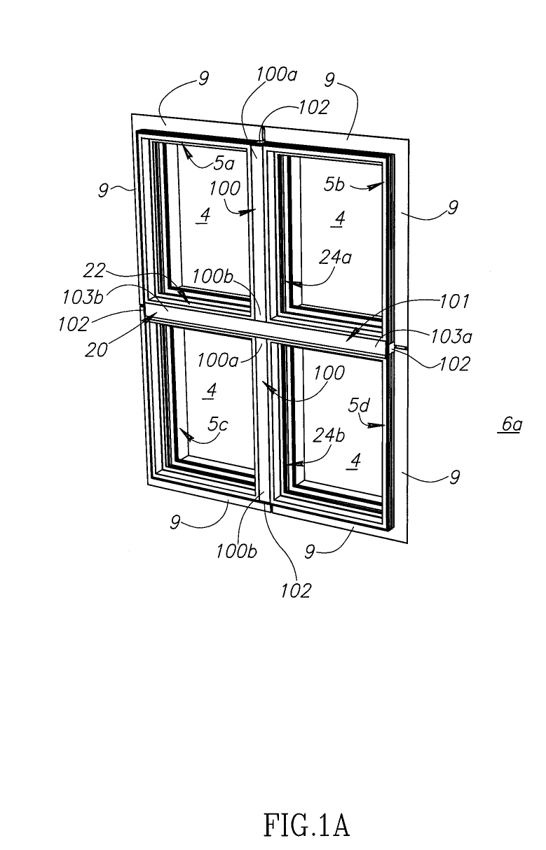

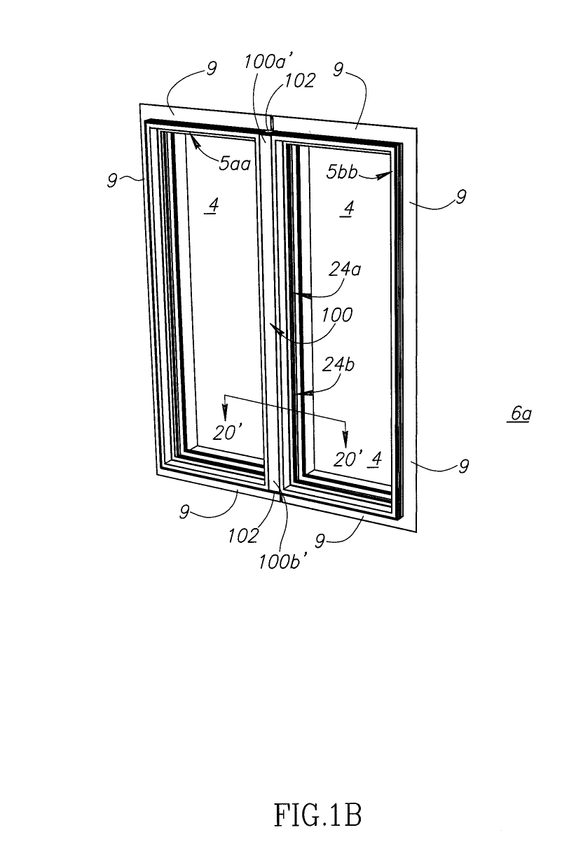

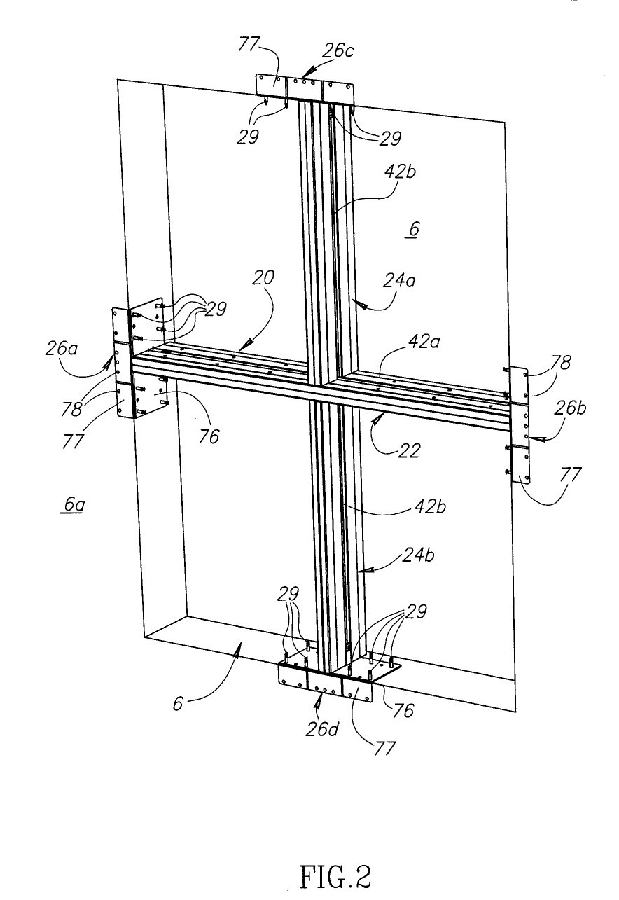

FIG. 1A shows the mullion system of the disclosed subject matter in an exemplary operation, supporting windows 4 in frames 5a-5d, in an opening 6 (FIG. 2), as seen from the outside or outer wall 6a of a building, structure or the like. The frames 5a-5d include fins 9 (also known as nail fins) that cover space in the opening 6 (also referred to herein as a window opening, window frame opening or rough opening) not filled by the frames 5a-5d. FIG. 1B is similar, except that the mullion system is employed on two windows 4 in window frames 5aa, 5bb, respectively, joined horizontally.

FIG. 2 is the same view as FIG. 1A, showing the mullion system 20 reinforcements 22, 24a, 24b, that support the window frames 5a-5d. The reinforcement system would be similar for the windows frames 5aa, 5bb of FIG. 1B, and is in accordance with the system described below. The mullion system 20 includes a horizontal reinforcement 22 that supports vertical reinforcements 24a (upper), 24b (lower). The horizontal reinforcement 22 is received in oppositely disposed gusset plates 26a (left, with respect to the paper), 26b (right, with respect to the paper). The vertical reinforcements 24a, 24b are supported by frictional interlocks with the horizontal reinforcement 22 and receipt in the respective gusset plate 26c (upper, with respect to the paper), 26d (lower, with respect to the paper). The gusset plates 26a-26d attach to the opening 6 and the outer wall 6a of the opening, through fasteners 29, for example, nails and the like and also including adhesives and the like.

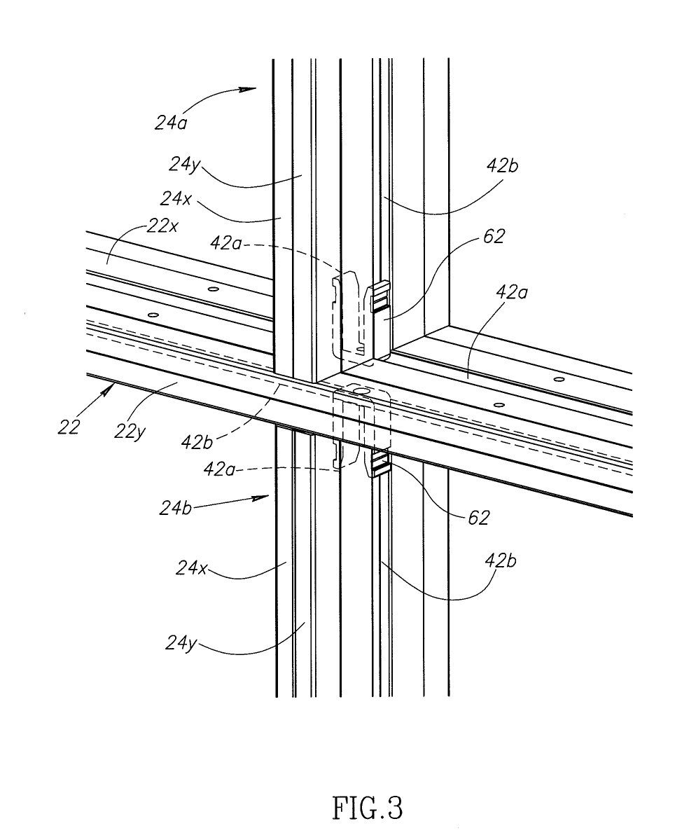

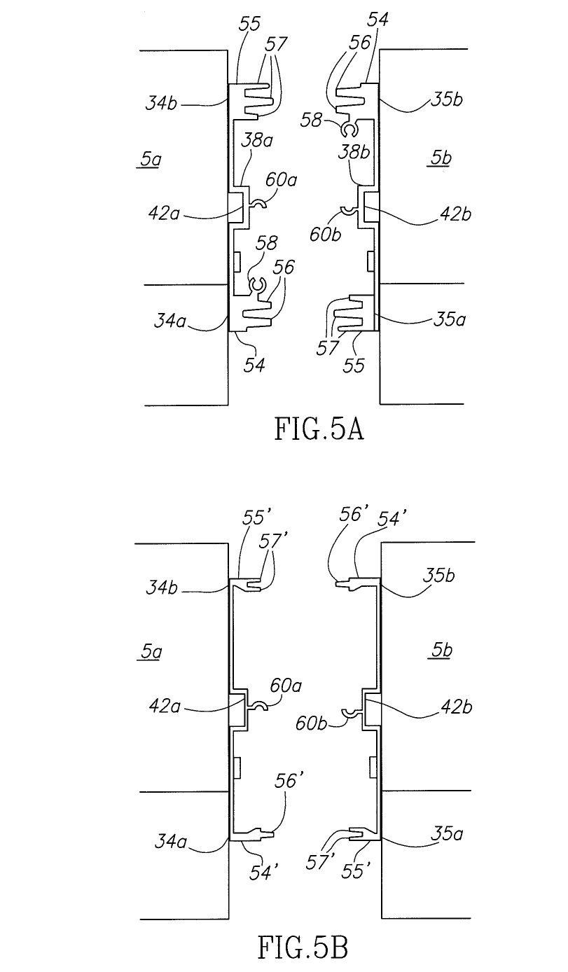

FIG. 3 shows the horizontal reinforcement 22 and vertical reinforcement 24a, 24b in greater detail. Each reinforcement 22, 24a, 24b is formed of paired members 22x, 22y and 24x, 24y, that include interengaging components, for joining and retaining the members 22x, 22y, 24x, 24y together (shown in FIGS. 5A and 5B and detailed below). Each of the members 22x, 22y, 24x, 24y may be joined to the window frame 5a-5d either before or during the overall mounting process of the mullion system. The members 24x, 24y are shown joined by a key 62 (detailed below), at least a portion of each key 62 seating in the groove 42a, 42b on the outer surface 44a, 44b of the respective members 22x, 22y (the structure of the members 22x, 22y, 24x, 24y and the key 62 detailed further below).

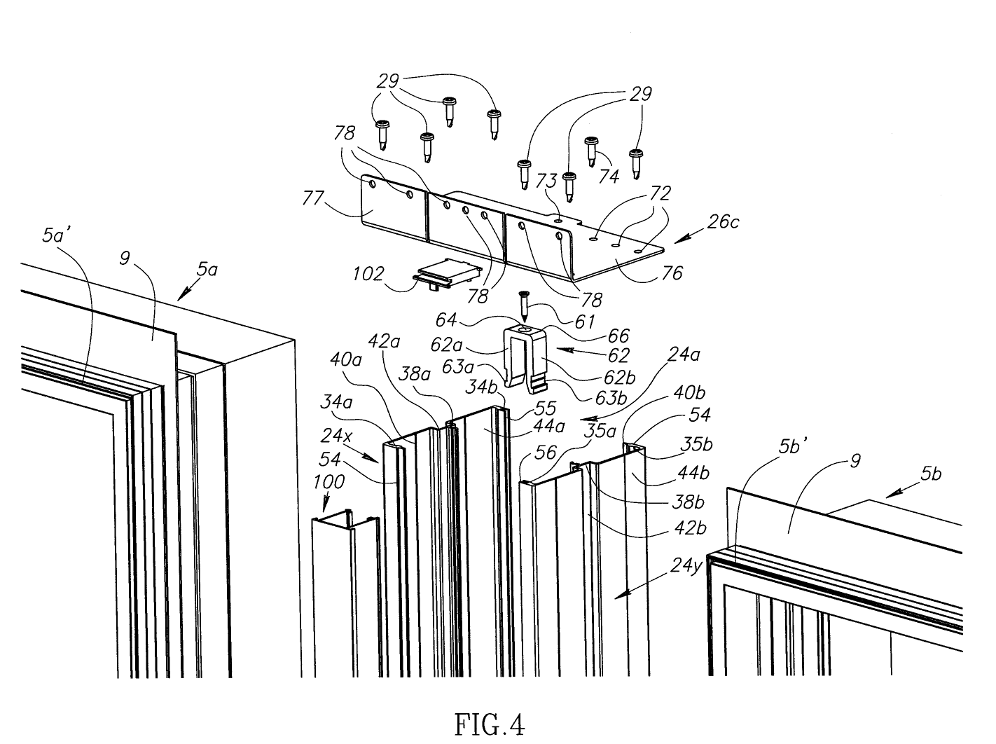

FIG. 4 shows the mullion system 20 in an exploded view, as viewed from the upper vertical reinforcement 24a. Each member 24x, 24y attaches to the respective window frame 5a, 5b. Additionally, the features of the members 24x, 24y discussed below are also applicable to members 22x and 22y, that for purposes of discussion, are similar except for their orientation in the window opening 6.

Each member 24x, 24y, as well as members 22x, 22y, are made, for example, from extruded materials such as steel, aluminum, plastic or the like. The members 24x, 24y, as pairs, include inwardly bent ends 34a, 34b, 35a, 35b, and an inwardly protruding ridge 38a, 38b, intermediate the bent ends 34a, 34b, 35a, 35b, for example, at the midpoint. The inwardly protruding ridge, 38a, 38b on the inner surface 40a, 40b of each member 24x, 24y, is shaped to correspond to a groove 42a, 42b on the outer surface 44a, 44b of each member 24x, 24y.

The ends 34a, 34b of one member 24x include finger portions 54, 55 that are correspondingly configured with finger portions 55, 54 on the ends 35a, 35b of the other member 24y, to form, for example, male-female friction fits, between the fingers 56, 57. For example, each member 24x, 24y includes one male finger portion 54 of, for example, two fingers 56, and one female finger portion 55, of three fingers 57, as shown in FIG. 5A. The finger portions 54 may include a screw boss 58 attached thereto for receiving screws 74 that secure the gusset plate 26a-26d to the respective reinforcement 22, 24a, 24b, as detailed below. For example, this arrangement of finger portions 54, 55 is referred to as a High Performance Reinforcement.

Alternately, the arrangement of finger portions 54, 55 on the ends 34a, 34b, 35a, 35b of the respective members 24x, 24y can be replaced with the arrangement of FIG. 5B, with male finger portions 54′ on each of the members 24x, 24y, of one finger 56, and female finger portions 55′ on each of the members 24x, 24y, respectively, with two fingers 57. For example, this arrangement of finger portions 54′, 55′ is referred to as a Standard Performance Reinforcement.

While the High Performance and Standard Performance reinforcements with finger portions 54, 55 are shown, there may be embodiments of members 24x, 24y where these finger portions 54, 55 are not present.

The distances between the fingers 56, 57 and 56′, 57′ are such that the fingers are received in a frictionally snug engagement, sufficient to keep the members 24x, 24y (and also of the lower vertical reinforcement 24b and horizontal reinforcement members 22x, 22y) held together until physically separated.

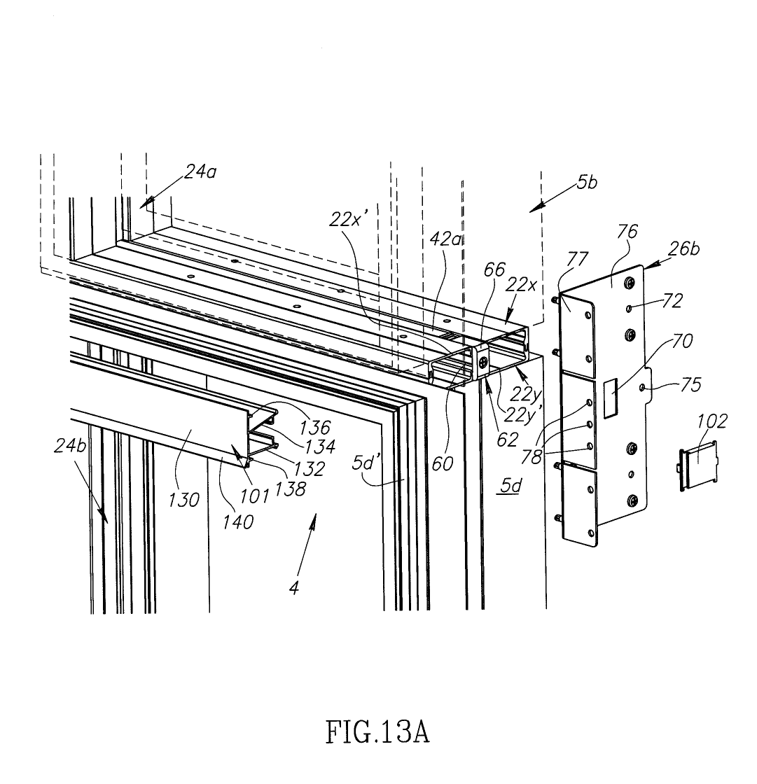

In both FIGS. 5A and 5B, at the ridge 38a, 38b are links 60a, 60b. These links 60a, 60b are, in the embodiment shown, “question mark” shaped, extend from the ridges 38a, 38b for interlocking with each other. The “C” shaped portions of the links 60a, 60b, when brought together define a boss (screw boss) 60 (FIG. 13A) for receiving a screw 61, that secures a key 62, to the respective reinforcement 22, 24a, 24b. The screw 61 is a non structural screw, as it serves only an attachment (securement) function.

The key 62 includes arms 62a, 62b that are of a width to seat in the grooves 42a, 42b of the respective members 24x, 24y. The arms 62a, 62b terminate in rounded portions 63a, 63b that extend outward, to facilitate engagement of the joined members 24x, 24y. The arms 62a, 62b are of a thickness, to fit within the space of the grooves 42a, 42b and not extend outside of the grooves 42a, 42b (remaining approximately flush with the respective outer surface 44a, 44b). The key 62 includes an opening 64 in its cross bar 66, the opening 64 for receiving the screw 61. The cross bar 66 extends between the arms 62a, 62b, giving the key 62 a “U” shape. The key 62 is, for example, a unitary member of metal, that holds the members 24x, 24y together by a clamping-type engagement. When attached and fastened to the members 24x, 24y, the key 62, extends beyond the edges of the joined members 24x, 24y.

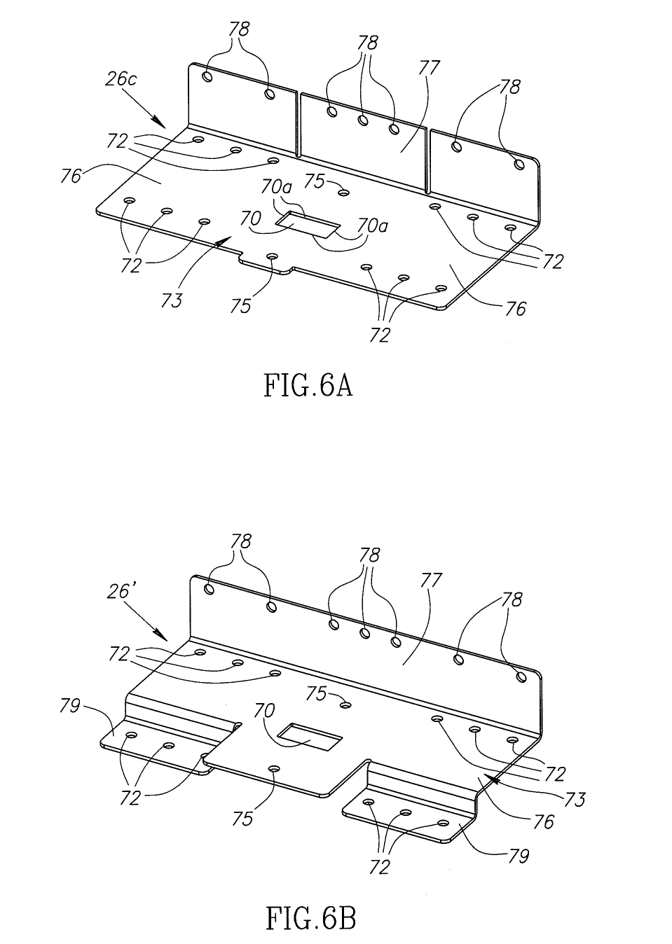

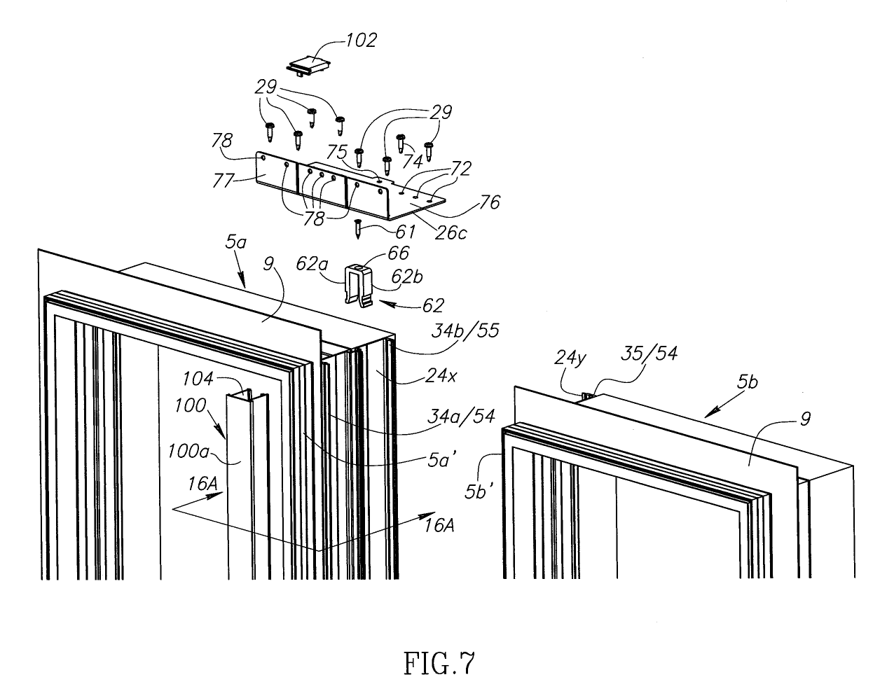

FIG. 6A shows a gusset plate 26c, exemplary of the other gusset plates 26a, 26b and 26d, with an opening 70, that is designed for receiving the cross bar portion 66 of the key 62 (that extends from the respective reinforcement 22, 24a, 24b). The gusset plate 26c is designed to attach to the window frames 5a, 5b to the rough opening 6, via fasteners 29, that are load bearing. The fasteners 29, for example, screws, nails, rivets, etc., extend through openings 72 in the body 73 of the gusset plate 26c. Screws 74 (FIG. 7) extend through openings 75 in the body 73 (that align with the screw bosses 58), for receipt in the screw bosses 58, for additional securement of the reinforcements 22, 24a, 24b to the respective gusset plates 26a-26d. The end portion 77 of the gusset plate 26c is also, for example, oriented perpendicular to the body 73, and includes openings 78 for fasteners, that attach the gusset plate 26c and the window frames 5a, 5b to the outer wall 6a of the building. This end portion 77, for example, is positioned behind the fins 9 of the frames 5a, 5b.

FIG. 6B is similar to FIG. 6A (like or identical components have the same numbers) and shows an alternate gusset plate 26′. This gusset plate includes platforms 79 on the end opposite the end portion 77, for accommodating double hung window frames.

Returning to FIG. 4, a mull strip or strips 100 (with ends 100a (e.g., upper), 100b (e.g., lower), as shown in FIG. 1A (multiple, with ends 100a, 100b) and 1B (single, with ends 100a′, 100b′)) is covered by a cap 102 (at ends 100a and 100b in FIG. 1A and 100a′ (e.g., upper) and 100b′ (e.g., lower) in FIG. 1B), that is clamped between the window frames 5a, 5b, 5c, 5d (FIG. 1A) and 5aa and 5bb (FIG. 1B), at the reinforcements 24a, 24b (shown for FIG. 1A). The mull strip 100 is on the outside surface of the window frames 5a, 5b, 5c, 5d, and 5aa, 5bb, and is exposed to the ambient environment. The mull strip or strips 100, as detailed below, are designed to move water out of the mull cavity 104, to the ambient environment, to inhibit rust formation, undue wear of the window frame components, rotting, or other untimely spoilage of the window frame components. This discussion is also applicable to the mull strip 101 (FIG. 1A), that is a single strip extending horizontally between window frames 5a and 5c and 5b and 5d. Alternately, in FIG. 1A, the vertical mull strip 100 may be a single strip bisecting multiple horizontal mull strips (each horizontal mull strip similar in construction to mull strip 101), in accordance with the discussion herein.

Attention is now directed to FIGS. 7-11 to show assembly of the mullion system of the disclosed subject matter, for example, the upper vertical reinforcement member 24a. In FIG. 7, the members 24x, 24y are attached to the window frames 5a, 5b, respectively. The attachment is with fasteners 29, such as nails, screws, rivets and the like and may also involve adhesives.

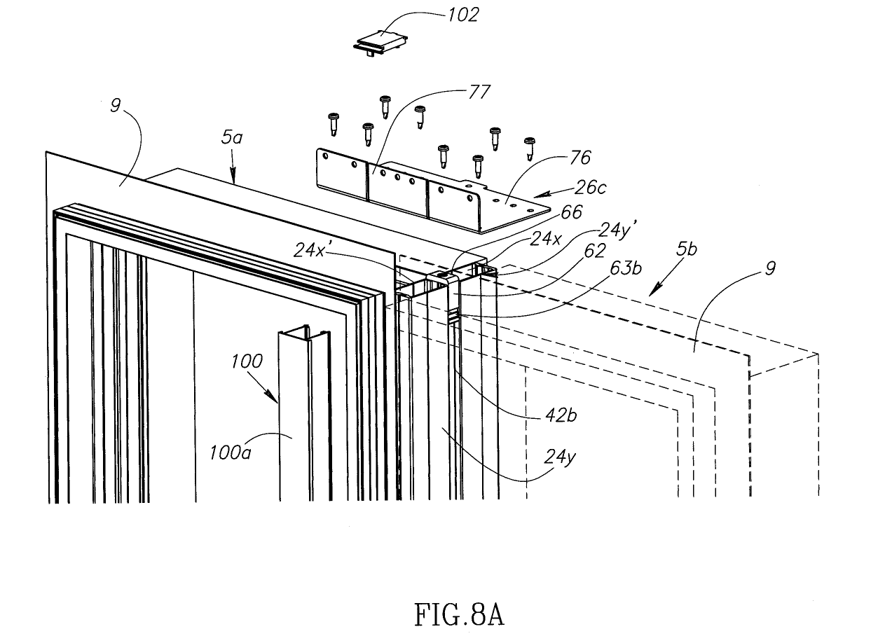

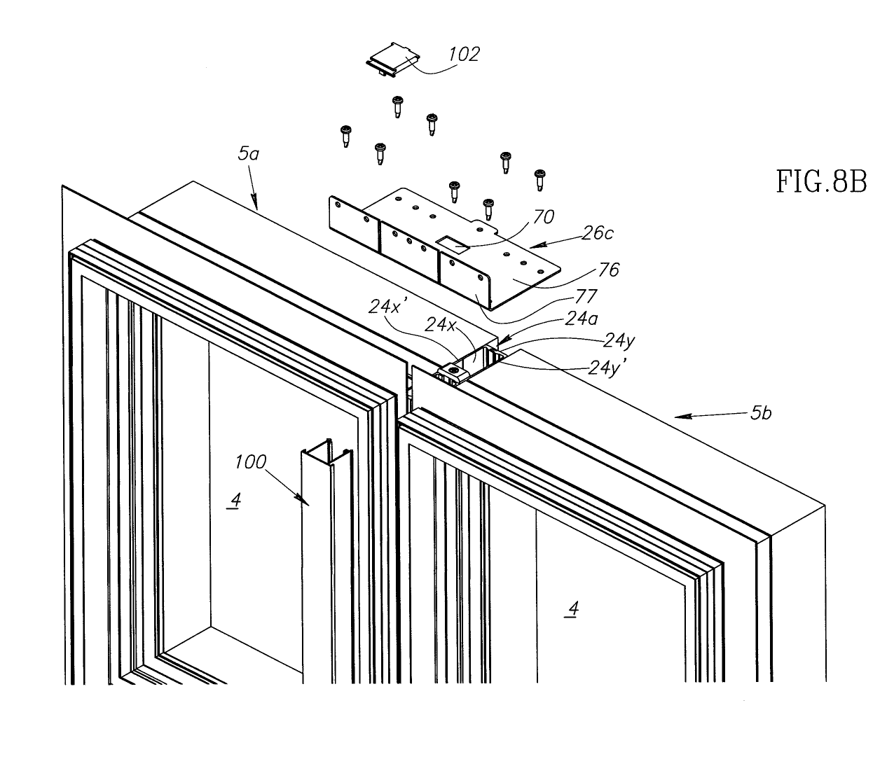

In FIGS. 8A and 8B, the members 24x, 24y are now brought together as the fingers 54, 55 (FIG. 5A) interlock and the links 60a, 60b (FIG. 5A) come together to define a screw boss 60. The key 62 is pushed downward, into contact with the members 24x, 24y and its arms 62a, 62b rest in the respective grooves 42a, 42b. Downward movement stops when the crossbar 66 of the key 62 abuts the edges 24x′, 24y′ of the members 24x, 24y.

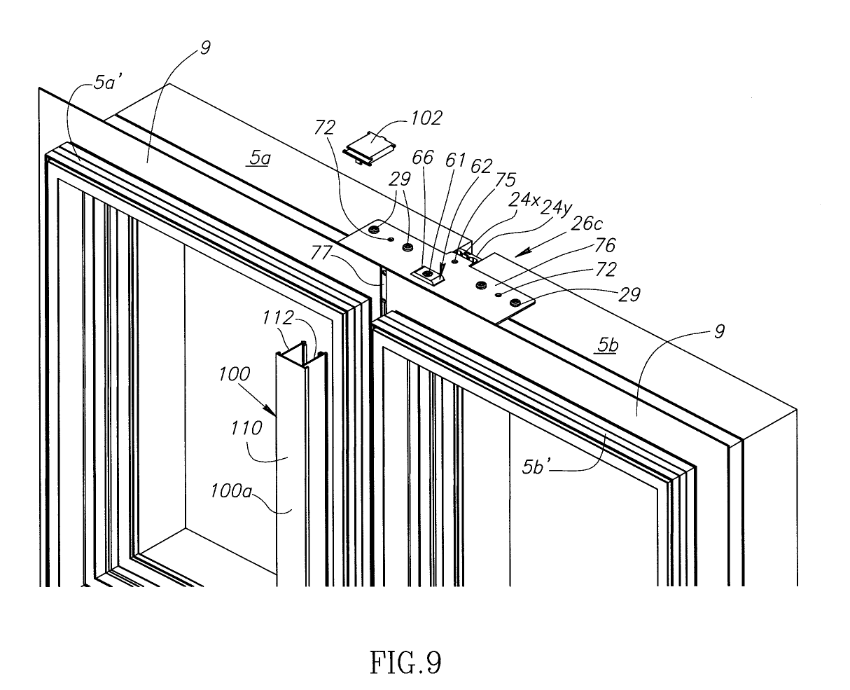

The gusset plate 26c is now attached to the joined frames 5a, 5b, as shown in FIG. 9. Orientation of the gusset plate 26c is such that the opening 70 is placed around the key 62 proximate the crossbar 66 and the key 62 is surrounded by the sidewalls 70a of the opening 70, where movement would cause an abutment with one or more of the sidewalls 70a, such that the key remains in place in the gusset plate 26c. This positioning of the key 62 allows some of the wind load on the window frames 5a-5d to be transferred to the key 62, such that the aforementioned wind load is distributed among the key 62 and the gusset plate fasteners 29.

The lower end of the vertical member 24a is joined similarly with a key 62 and screw 61. The extending crossbar 66 of the key 62 will seat in the groove 42a of the horizontal member 22x, as shown in FIGS. 2, 3 and 15.

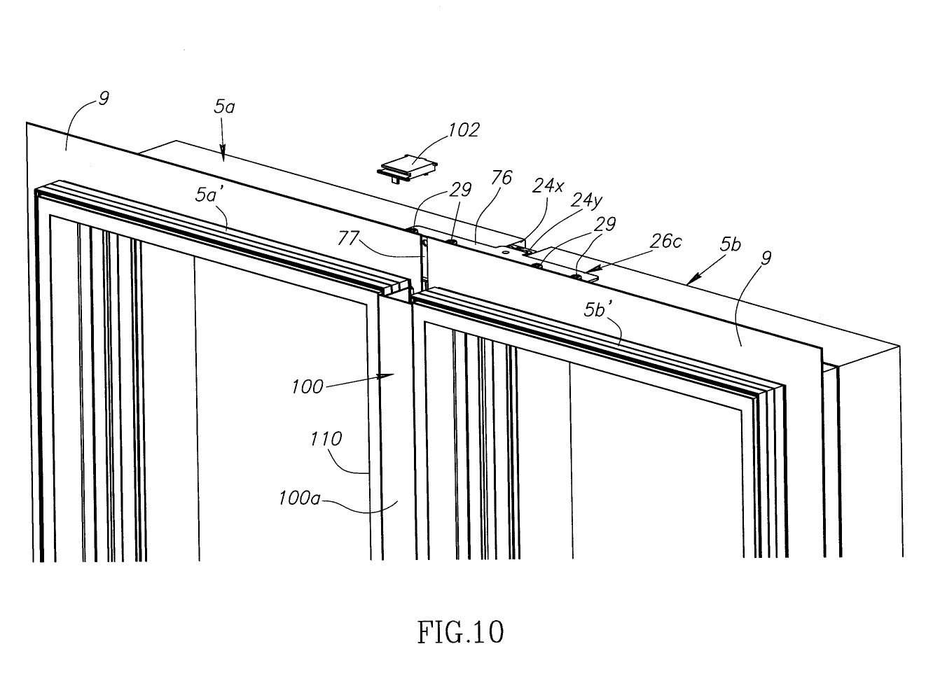

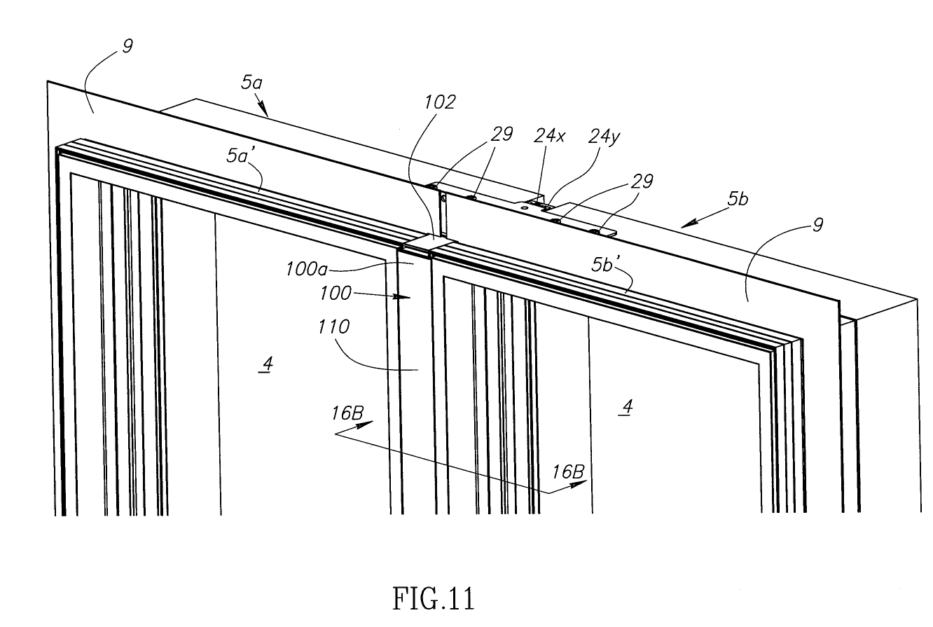

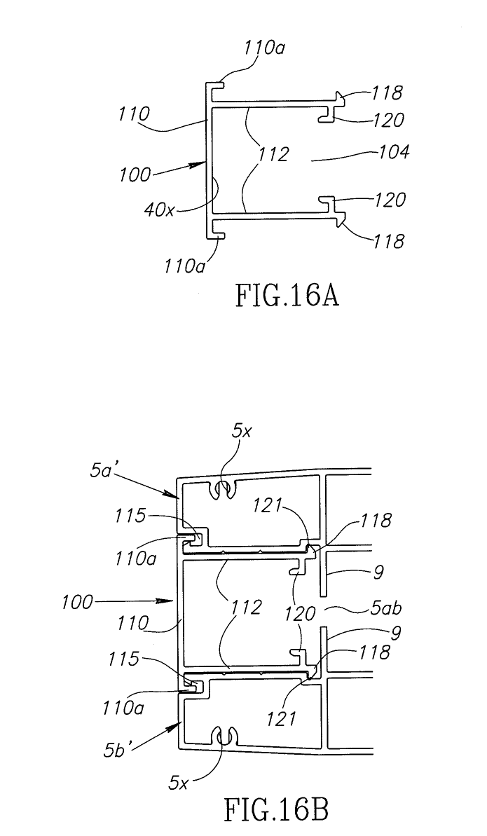

The mull strip 100 is placed between the window frame edges 5a′, 5b′, and it snaps into place, due to the resiliency of the materials from which it is made (e.g., aluminum, polymers, plastics, elastomers), as shown in FIG. 10. As shown in FIG. 11, a cap 102 is joined to the mull strip 100 at its upper end 100a (of the upper mull strip 100), and at the lower end 100b of the lower mull strip 100 (as shown in FIG. 1A). The cap 102 closes the mull cavity 104 of the mull strip(s) 100. The cap 102 may be frictionally fit into the mull strip 100, and this attachment may be facilitated with additional adhesives and other adhesive techniques. The mull strips 100 are described in greater detail below and shown in FIGS. 16A and 16B.

The lower vertical reinforcement 24b is constructed similarly and assembled as detailed above. The extending crossbar 66 of the key 62 will seat in the groove 42b of the horizontal member 22x, as shown in FIGS. 2, 3 and 15, at the upper end of the vertical reinforcement 24b, and in the opening 70 of the gusset plate 26d at the lower end of the vertical reinforcement 24b.

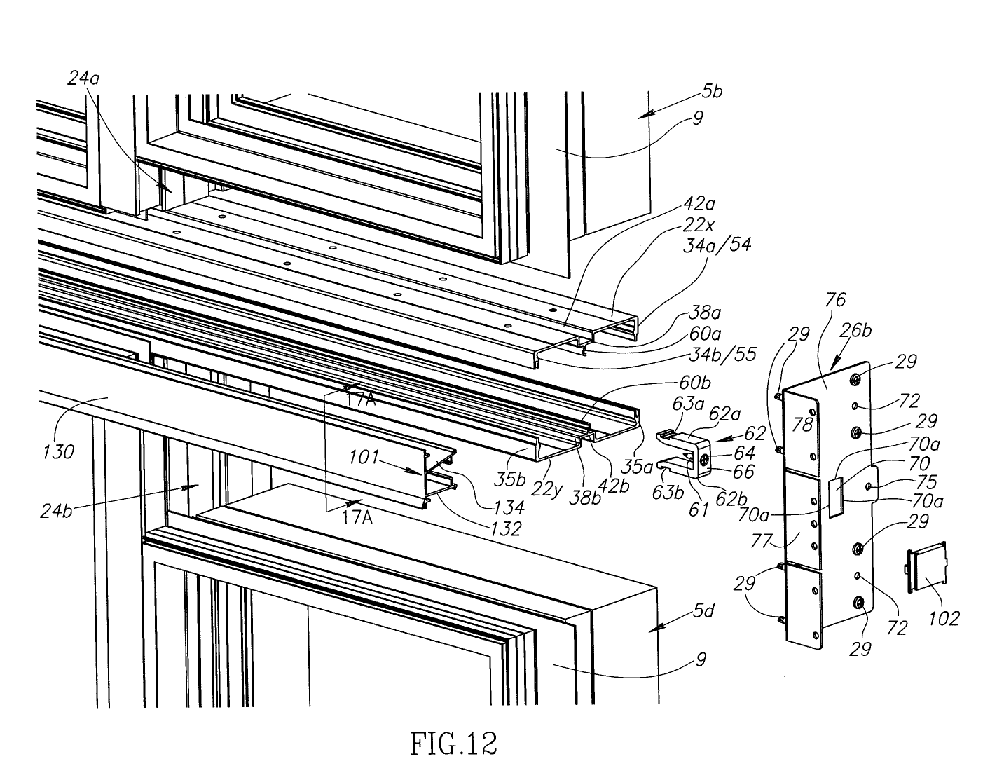

Attention is now directed to FIGS. 12-15 to show assembly of the mullion system of the disclosed subject matter, from the standpoint of the horizontal reinforcement 22, formed of paired members 22x, 22y. The additional components are the same as detailed above, only in a horizontal orientation. Although a single side of the reinforcement members 22x, 22y is shown, the reinforcement members 22x, 22y are symmetric and accordingly, applies equally to the side not shown, the side that engages the gusset plate 26a.

FIG. 12 is an exploded view of all of the components of the mullion system. In FIGS. 13A and 13B, the members 22x, 22y have been attached to the window frames 5a, 5c and 5b, 5d, and are joined together by interlocking of the respective finger portions 54, 55, and secured by the key 62, that seats in the grooves 42a, 42b (the crossbar 66 abutting the edges 22x′, 22y′ of the members 22x, 22y). The key 62 is held in place by a screw 61, as detailed above.

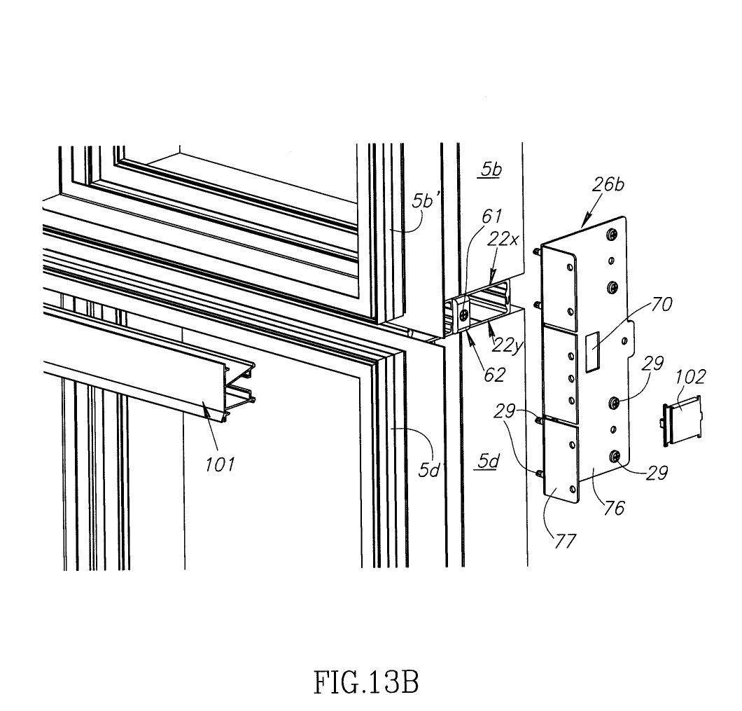

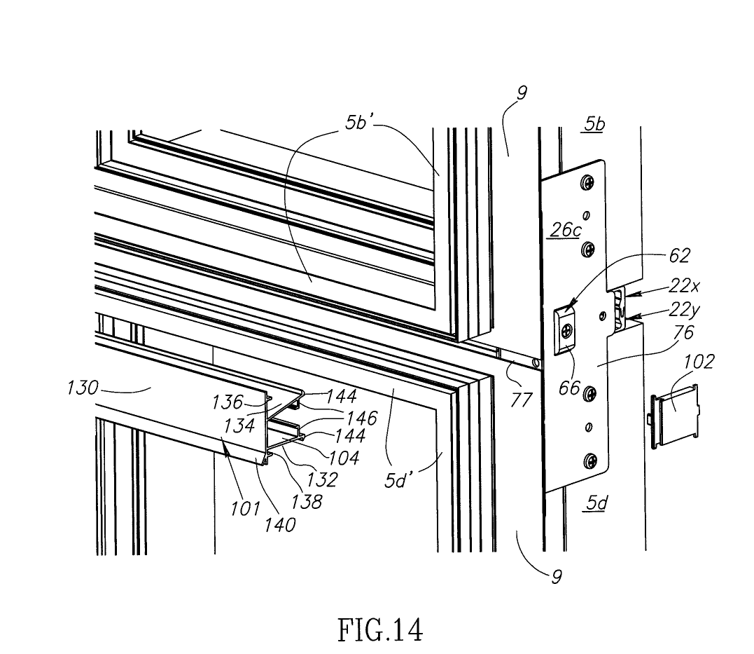

The gusset plate 26b is now attached to the joined frames 5b, 5d, as shown in FIG. 14. Orientation of the gusset plate 26b is such that the opening 70 is placed around the key 62 proximate the crossbar 66 and the key 62 is surrounded by the sidewalls 70a of the opening 70, where movement would cause an abutment with one or more of the sidewalls 70a. The end portion 77 of the gusset plate 26b is close to or in abutment with the fins 9 of the window frames 5b, 5d.

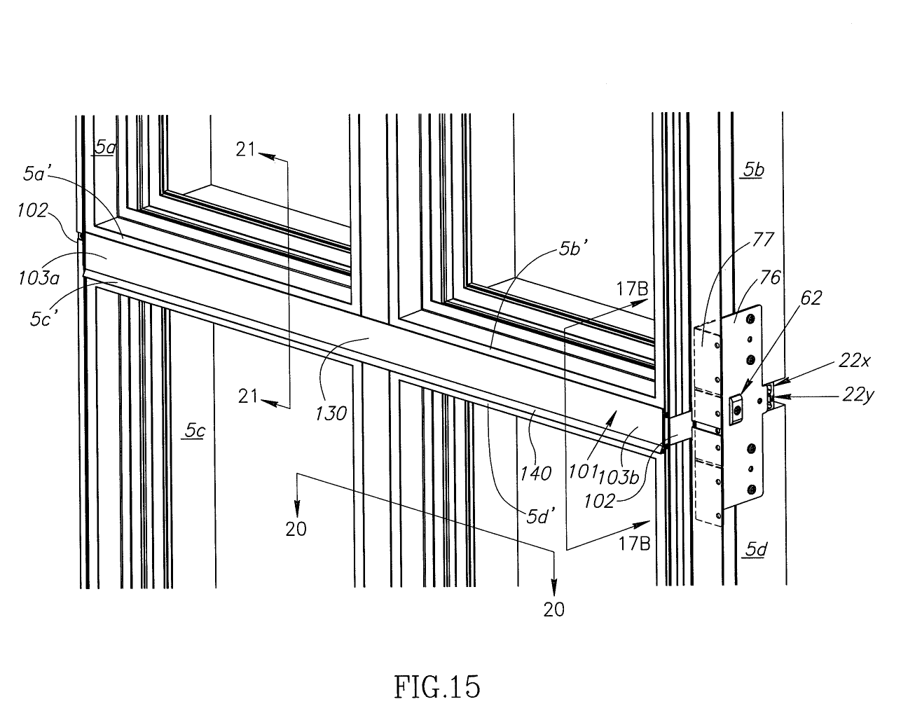

In FIG. 15, the mull strip 101 is placed between the window frame edges 5a′, 5c′ and 5b′, 5d′, and it snaps into place, due to the resiliency of the materials from which it is made, as detailed above. Caps 102 are joined to the mull strip 101 at both lateral ends 103a, 103b, to close the cavity 104 (FIG. 16A) of the mull strip 101, as detailed above. Like the mull strip 100, mull strips 101, 101′, detailed below, are designed to move water out of the mull cavity 104 (FIG. 16A), to the ambient environment, to inhibit rust formation, undue wear of the window frame components, rotting, or other untimely spoilage of the window frame components.

FIGS. 16A-18B detail vertical 100 and horizontal 101, 101′ mull strips. The vertical mull strip 100 has been shown in FIGS. 1A, 1B, 4, 5 and 7-11, while the horizontal mull strip 101 has been shown in FIGS. 1A, 12-15. Mull strip 101′ is an alternate horizontal mull strip.

The vertical mull strip 100 of FIG. 16A is symmetric, and, for example, “C” shaped. A cross member 110 includes oppositely disposed lateral members 112. The cross member 110 includes inwardly extending arms 110a for engaging slots 115 in the window frame edges 5a′, 5b′ (that may include screw bosses 5x that receive joining screws and the like), an inner surface 110x. The lateral members 112 terminate in outwardly extending flanges 118, and inwardly extending “L” shaped tabs 120. These tabs 120 are used in mull strip 100 removal from the space (gap) between the window frame edges 5a′, 5b′.

As shown in FIG. 16B, the cross member 110 faces the ambient environment (outside), while the lateral members 112 are inside the space between the window frame edges 5a′, 5b′. The flanges 118 of the lateral members 112, engage shoulders 121 of the window frame edges 5a′, 5b′. The flanges 118 are tapered, to facilitate inward sliding of the mull strip 100, until the flanges 118 snap into place in the shoulders 121. The tabs 120 serve to keep water within the mull strip 100, so that it may drain properly.

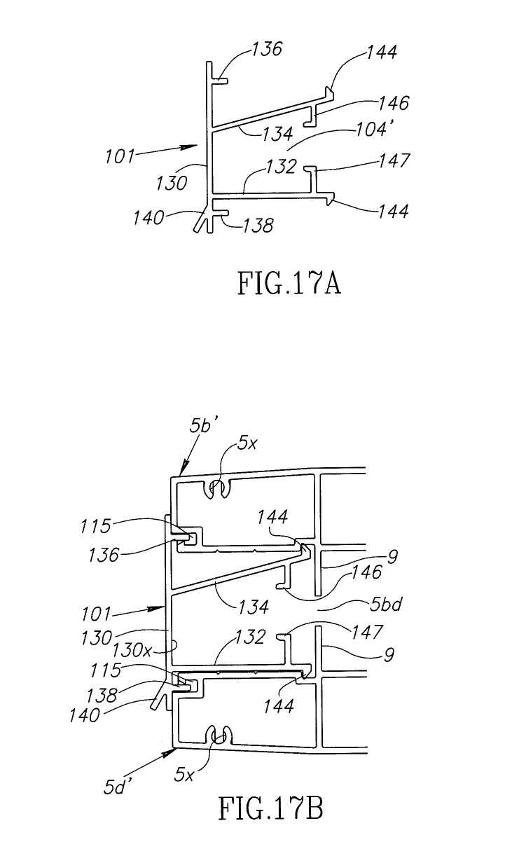

In FIG. 17A, the horizontal mull strip 101 includes a cross member 130, with an inner surface 130x (FIG. 17B). The cross member 130 contacts the ambient environment, with a perpendicular lateral member 132 and an upwardly (outwardly) angled lateral member 134. Turning also to FIG. 17B, inwardly protruding stubs 136 (upper) 138 (lower) are designed to engage slots 115 in the window frame edges 5a′, 5c′ and 5b′, 5d′. An outwardly protruding ledge or ledge member 140 extends angularly from the cross member 130, to direct water away from the mull strip 101, and forms the lower end of the mull strip 101. The lateral members 132 terminate in outwardly extending flanges 144, that function similarly to the flanges 118, and inwardly extending “L” shaped tabs 146 (upper), 147 (lower). These tabs 146, 147 function similarly to tabs 120 for the mull strip 100, with the tab 147 also operable to keep water within the mull strip 101, so that it may drain properly.

In operation, the upwardly angled lateral member 134 allows water to move toward the exterior of the mullion system, such that it drains out via the mull caps 102. As shown in FIG. 17B, the mull strip 101 is oriented such that the upwardly angled lateral member 134 defines the upper side of the mull strip 101, while the angularly protruding ledge or ledge member 140 defines the lower side of the mull strip 101.

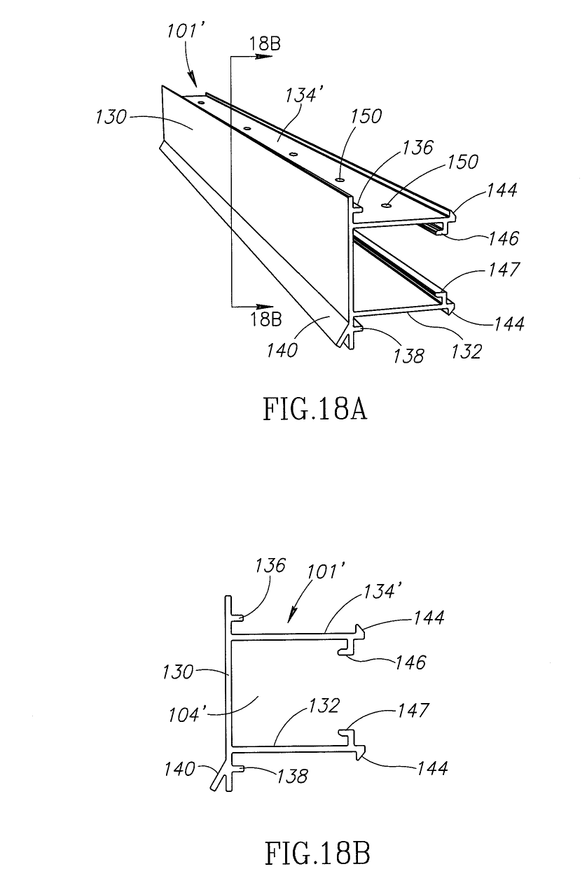

The horizontal mull strip 101′ of FIGS. 18A and 18B is similar to the mull strip 101, except that a perpendicularly oriented (with respect to the cross member 130) member 134′ is the upper lateral member. This upper lateral member includes indicia 150 (FIG. 18A) where openings may be cut or drilled, to facilitate water drainage, or the indicia may be replaced by openings. In operation, the mull strip 101′ is oriented such that the upwardly lateral member 134′ defines the upper side of the mull strip 101′, while the angularly protruding ledge or ledge member 140 defines the lower side of the mull strip 101′.

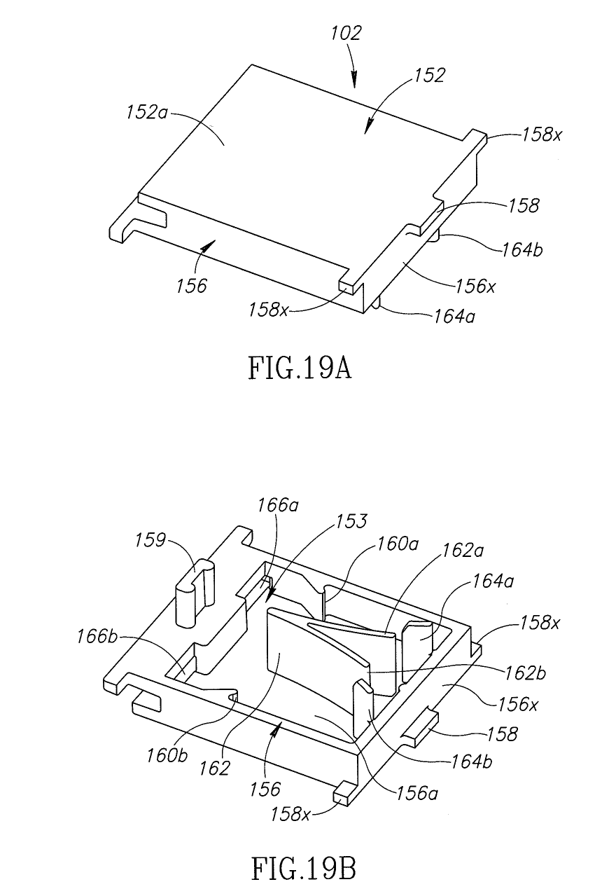

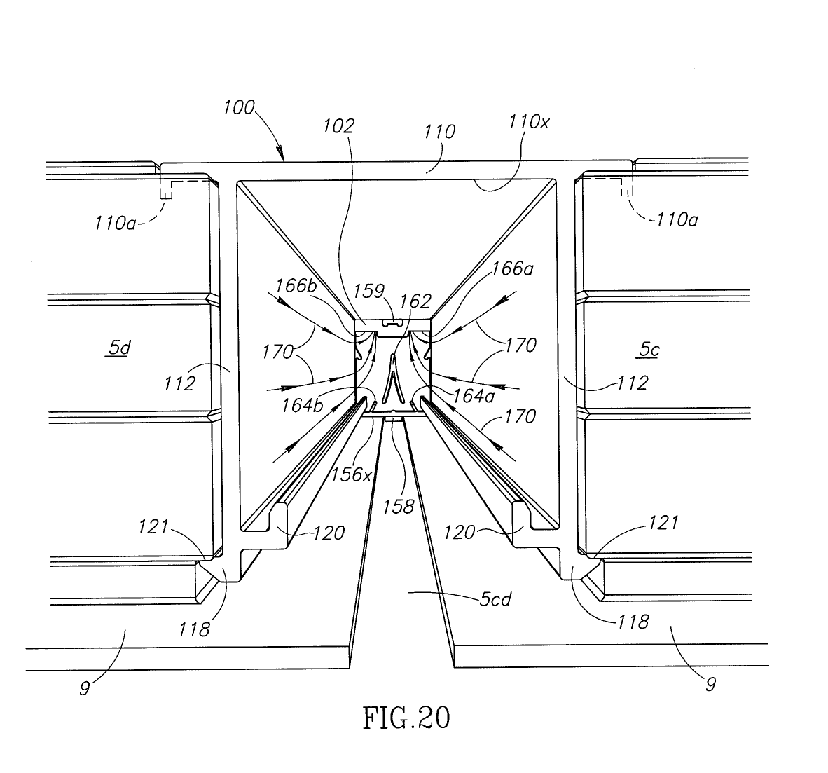

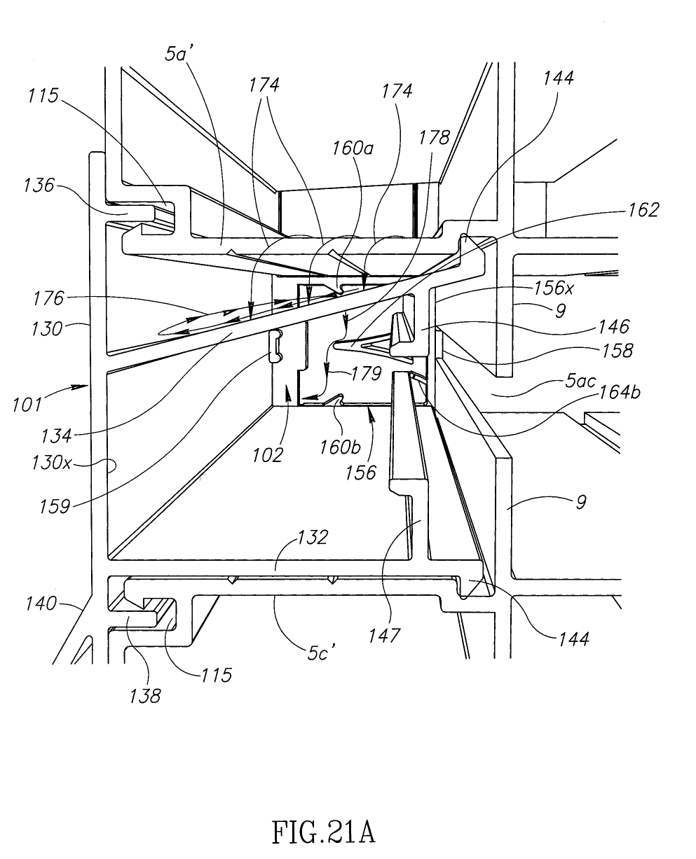

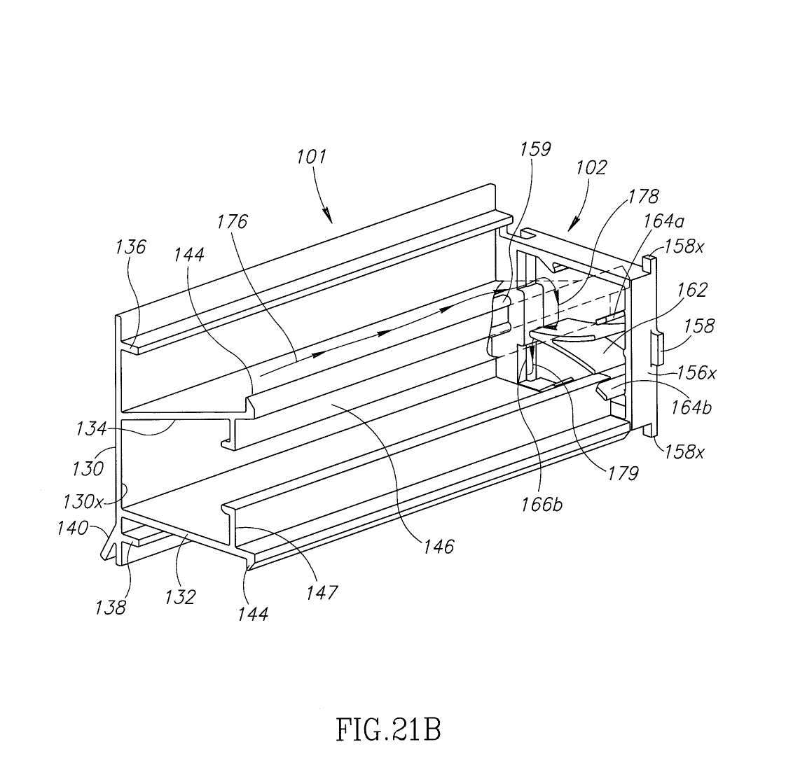

FIGS. 19A and 19B show the mull cap 102, from its outer side 152 (FIG. 19A) and its inner side 153 (FIG. 19B). The cap 102 includes a peripheral wall 156, with a wall segment 156x, from which a protrusion 158 extends. This protrusion 158 is, for example, flush with the outer surface 152a. This protrusion 158 is received in a slot 5ac formed between the joined window frames 5a, 5c (shown in FIG. 21A as exemplary for the entire system 20, and joined window frames 5b and 5d). Ears 158x, that are optional, extend from the segment 156x, and provide additional surface for a friction fit, as detailed below. The segment 156x, protrusion 158, and, if provided, the ears 158x, frictionally engage the nail fins 9 (detailed in FIGS. 20 and 21A below).

Another protrusion 159 extends from the inner side 153. This protrusion 159 serves to frictionally engage to the mull strip 101 at its closed side. The cap 102 may be additionally secured to the mull strip 101 by adhesives and the like.

The inner side 153 of the cap 102 includes veins 160a, 160b that extend from the peripheral wall 156 and are oriented to direct water downward (toward vein 160b), when the cap 102 is engaged on the mull strip 101, as shown in FIGS. 21A and 21B. A V-shaped main vein 162 extends from the inner surface 156a of the inner side 153 and is oriented also to direct water downward, toward the vein 160b. The main vein ends 162a, 162b coupled with stubs or stub members 164a and 164b, that extend from the peripheral wall 156, cooperate to function in engaging the cap 102 to the mull strip 101 by frictionally contacting the respective tabs 146, 147 of the mull strip 101. Openings, also known as weep holes, 166a, 166b are proximate to the veins 160a, 160b at the front end of the cap 102.

FIG. 20 shows the cap 102 mounted on a mull strip 100 and the mounting of the cap 102/mullstrip 100 as a vertical member in window frame members 5c and 5d, with a slot (gap) 5cd between the corresponding fins 9 of the respective window frames 5c, 5d. These figures also show a pathway for the water through the mull strip 100, to the mull cap 102. The water exits the system 20 through the mull cap 102, for example, through the openings 166a, 166b.

The mull strip 100 attaches between the window frame members 5c and 5d. The cap 102 fits over the mull strip 100 at its bottom (as shown) as well as its top (for example, as shown in FIGS. 1B and 11, with the description below applicable to the caps 102 at this top of the mull strip 100). The protrusion 158 extends into the slot 5cd, and wall segment 156x frictionally contacts the fins 9, and the protrusion 159 is in frictional contact with the mull strip 100, along an inner surface 110x.

Water flows downward in the direction of the arrow 170, through the mull strip 100 to the cap 102. Once at the cap 102, the water flows out of the openings 166a, 166b, to the ambient environment. The flow may be directed by the main vein 162, as well as the stub members 164a, 164b.

FIGS. 21A and 21B show the cap 102 mounted on a mull strip 101 and the mounting of the cap 102/mullstrip 101 as a horizontal member in window frame members 5a′ and 5c′, with a slot 5ac between the corresponding fins 9 of the respective window frames 5a, 5c (FIG. 21A). These figures also show a pathway for the water through the mull strip 101, to the mull cap 102 and exiting the mull cap 102, for example, through the opening 166b.

The mull strip 101 attaches between the window frame members 5a′ and 5c′ (and also window frame members 5b′ and 5d′), as shown in FIG. 15, and as described above. The cap 102 fits over the mull strip 101 at its side, with the protrusion 158 extending into the slot 5ac between the fins 9, the members 164a, 164b frictionally engaging the respective tabs 146, 147, and the wall segment 156x frictionally contacts the fins 9. The protrusion 159 is in frictional contact with the mull strip 101, along an inner surface 130x.

A drainage path for water, for example, in the form of condensate, is also shown in FIGS. 21A and 21B. Initially, water (moisture) falls from the window frame 5a′ onto the upper lateral member 134 (as indicated by the arrows 174). As the member 134 is angled slightly downward, the water now flows toward the mull cap 102, as indicated by the arrows 176. Once in the mull cap 102, the veins 160a, 162, 160b facilitate movement (weeping) of the water to the opening 166b, in accordance with the arrows 178. The water exits (weeps from) the cap 102 through the opening 166b as shown by the arrow 179.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

We claim:

1. A mullion system providing improved structural rigidity comprising:
a) a first component for being fastened to the frame of a first window unit;
b) a second component for being fastened to the frame of a second window unit; and,
c) a removably attachable reinforcement key configured for joining the first component to the second component, a leading portion of the reinforcement key extending beyond the edges of the first component and the second component, the extending portion configured for receipt in a securement member.

2. The system of claim 1, wherein the reinforcement key includes a U-shaped member and includes a cross bar portion with oppositely disposed arms extending from the cross bar portion, at least a portion of the cross bar portion defining the leading portion.

3. The system of claim 2, additionally comprising a gusset plate for attachment to a peripheral portion of an opening, the gusset plate defining a securement member, and including an opening for receiving the leading portion of the reinforcement key.

4. The system of claim 2, wherein the first component and the second component include a groove extending substantially along the outer side of each of the first and second components, intermediate the longitudinal ends of the component, the groove configured to receive the leading portion of the reinforcement key.

5. The system of claim 1, wherein the first component and the second component include inner sides, and correspondingly configured members for interlocking with each other extending from the inner sides of each of the components.

6. A system for placement between parallel oriented window frames for facilitating liquid flow out of the system, comprising:
a strip for placement into a space between the parallel oriented window frames, the strip including oppositely disposed ends, a main member including oppositely disposed first and second edges, a first lateral member extending from the main member proximate to the first edge, and a second lateral member extending from the main member proximate to the second edge, the first lateral member and the second lateral member extending substantially the same distance from the main member; and
at least one cap for covering the strip at least at one of the oppositely disposed ends, the at least one cap including an inner side including at least one opening to the ambient environment, the inner side configured for facilitating movement of liquid to the opening for egress from the at least one cap.

7. The system of claim 6, wherein the at least one cap includes two caps, each of the caps disposed at opposite ends of the strip.

8. The system of claim 6, wherein the at least one cap includes a first portion and a second portion for facilitating a frictional engagement with the strip and the portions of the window frames in which the strip sits.

9. The system of claim 8, wherein the first portion includes a first protrusion for frictionally contacting the strip and the second portion includes a wall segment for frictionally contacting the portions of the window frames.

10. The system of claim 9, wherein the at least one cap includes a second protrusion extending from the wall segment for fitting into a gap between portions of the window frames.

11. The system of claim 8, wherein the at least one cap includes veins for facilitating the movement of liquid from the strip to the opening.

12. The system of claim 6, wherein the first and second lateral members terminate in structures that engage corresponding portions of the widow frames in which the strip sits.

13. The system of claim 6, wherein the strip additionally comprises arms extending from the main member for receipt in openings in the portions of the window frames in which the strip sits.

14. The system of claim 6, wherein the first lateral member extends substantially perpendicular to the main member.

15. The system of claim 14, wherein the second lateral member extends substantially perpendicular to the main member.

16. The system of claim 14, wherein the second lateral member extends angularly outward from the main member.

17. The system of claim 6, additionally comprising: a ledge member extending from the main member at an angle, the ledge member proximate to the first edge of the main member.

18. The system of claim 16, wherein the at least one cap includes a plurality of stub members extending from the inner wall and the strip includes tabs extending from the first and second members, the tabs and stubs members positioned to frictionally engage each other.

19. A system for placement between vertically oriented window frames for diverting liquid, comprising:
a strip for placement into a space between vertically oriented window frames, the strip including oppositely disposed ends, the strip including a main member including an upper edge and a lower edge, a first lateral member protruding from the main member proximate to the lower edge, and a second lateral member protruding upward from the main member proximate to the upper edge, the first lateral member and the second lateral member extending at least substantially the same distance as the main member; and
at least one cap for frictionally fitting in an area formed by the an oppositely disposed end of the strip and portions of the window frames, the at least one cap including an inner side and at least one opening to the ambient environment, the inner side configured for receiving and facilitating movement of liquid to the opening for egress from the at least one cap.

20. The system of claim 19, wherein the at least one cap includes two caps, each cap for engagement at each of the oppositely disposed ends of the strip.

21. The system of claim 19, wherein the at least one cap includes a first portion for frictionally engaging the main member and a second portion for frictionally engaging the portions of the window frames in which the strip sits.

22. The system of claim 21, wherein the at least one cap includes veins for facilitating the movement of liquid from the strip to the opening.
